(19) United States
(12) Patent Application Publication
(10) Pub. No.: US 2025/0081023 A1
(43) Pub. Date: Mar. 6, 2025

(54) METHODS AND DEVICES FOR CONFIGURING INTERFERENCE MEASUREMENT AND REPORTING

(71) Applicant: ZTE Corporation, Shenzhen (CN)

(72) Inventors: Xing LIU, Shenzhen (CN); Xianghui HAN, Shenzhen (CN); Shuaihua KOU, Shenzhen (CN); Xingguang WEI, Shenzhen (CN); Jing SHI, Shenzhen (CN); Jian Li, Shenzhen (CN)

(73) Assignee: ZTE Corporation, Shenzhen (CN)

(21) Appl. No.: 18/953,309

(22) Filed: Nov. 20, 2024

Related U.S. Application Data
(63) Continuation of application No. PCT/CN2022/122895, filed on Sep. 29, 2022.

(51) Int. Cl. H04W 24/10; H04W 72/0446

(52) U.S. Cl. CPC H04W 24/10; H04W 72/0446

(57) ABSTRACT

The present disclosure describes methods, system, and devices for configuring measurement subband configuration for interference measurement and reporting. One method includes determining, by a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and transmitting, by the UE, feedback information to a base station, the feedback information comprising measurement result for at least one MSB in the plurality of MSBs. Another method includes receiving, by a base station from a UE, an MSB configuration; and receiving, by the base station, feedback information from the UE.

### TECHNICAL FIELD

The present disclosure is directed generally to wireless communications. Particularly, the present disclosure relates to methods and devices for configuring interference measurement and reporting.

### BACKGROUND

Wireless communication technologies are moving the world toward an increasingly connected and networked society. In wireless communication system, time domain resource is split between downlink and uplink communications. An emerging trend in mobile communications is the parallel usage of multiple radio technologies. When there are both uplink and downlink communications in different frequency domain resource of a same time domain resource, cross-link interference for the time-frequency resources may occur, hindering the performance of the wireless communication.

The present disclosure describes various embodiments for configuring interference measurement and reporting, addressing at least one of issues/problems associated with cross-link interference for the time-frequency resources, providing improvement in the technology field of wireless communication and increasing its efficiency and performance.

### SUMMARY

This document relates to methods, systems, and devices for configuring measurement subband configuration for interference measurement and reporting, which may effectively configuration subband based cross-link interference (CLI) measurement and reporting with a reasonable feedback overheads, and/or obtain a more accurate measurement result for subsequent interference coordination.

In one embodiment, the present disclosure describes a method for wireless communication. The method includes determining, by a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and transmitting, by the UE, feedback information to a base station, the feedback information comprising measurement result for at least one MSB in the plurality of MSBs.

In one embodiment, the present disclosure describes a method for wireless communication. The method includes receiving, by a base station from a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and receiving, by the base station, feedback information from the UE, the feedback information comprising measurement result for at least one MSB in the plurality of MSBs.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of cross-link interference.

FIG. 2 shows an example of a network node.

FIG. 3 shows an example of a user equipment.

FIG. 4 shows a schematic diagram of a roll-off filter effect.

FIG. 5 shows a schematic diagram of a frequency range configured with one or more subbands.

FIG. 6 shows a flow diagram of a method for wireless communication.

FIG. 7 shows a flow diagram of another method for wireless communication.

FIG. 8 shows a schematic diagram of a non-limiting embodiment for wireless communication.

FIG. 9A shows a schematic diagram of another non-limiting embodiment for wireless communication.

FIG. 9B shows a schematic diagram of another non-limiting embodiment for wireless communication.

FIG. 9C shows a schematic diagram of another non-limiting embodiment for wireless communication.

FIG. 9D shows a schematic diagram of another non-limiting embodiment for wireless communication.

FIG. 9E shows a schematic diagram of another non-limiting embodiment for wireless communication.

FIG. 10 shows a schematic diagram of another non-limiting embodiment for wireless communication.

FIG. 11 shows a schematic diagram of another non-limiting embodiment for wireless communication.

FIG. 12 shows a schematic diagram of another non-limiting embodiment for wireless communication.

FIG. 13A shows a schematic diagram of another non-limiting embodiment for wireless communication.

FIG. 13B shows a schematic diagram of another non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring interference measurement and reporting.

Next generation (NG), or 5th generation (5G), wireless communication may provide a range of capabilities from downloading with fast speeds to support real-time low-latency communication. New generation (NG) mobile communication system are moving the world toward an increasingly connected and networked society. To meet more and more demands, the 4th Generation mobile communication technology (4G) Long-Term Evolution (LTE) or LTE-Advance (LTE-A) and the 5G mobile communication technology are developing supports on features of enhanced mobile broadband (eMBB), ultra-reliable low-latency communication (URLLC), and massive machine-type communication (mMTC). Full duplex is one of the developed feature for 5G and further communication system.

In some implementations of a wireless communication system, the time domain resource is split between downlink and uplink in time division duplex (TDD). Allocation of a limited time duration for the uplink in TDD would result in reduced coverage, increased latency and reduced capacity. As a possible enhancement on this limitation of the conventional TDD operation, it may be worth implementing the feasibility of allowing the simultaneous existence of downlink and uplink, a.k.a. full duplex, or more specifically, subband non-overlapping full duplex (SBFD) at a base station side (e.g., gNB) within a conventional TDD band. There may be both uplink and downlink in different frequency domain resource of a same time domain resource.

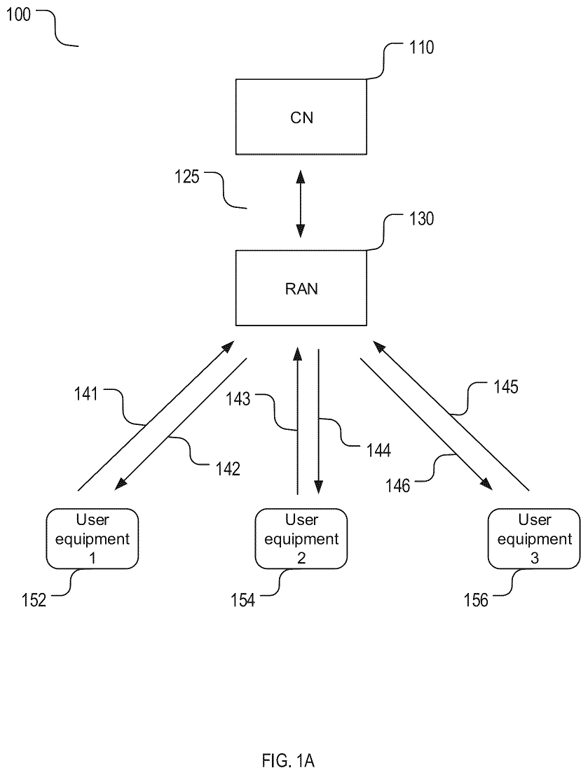

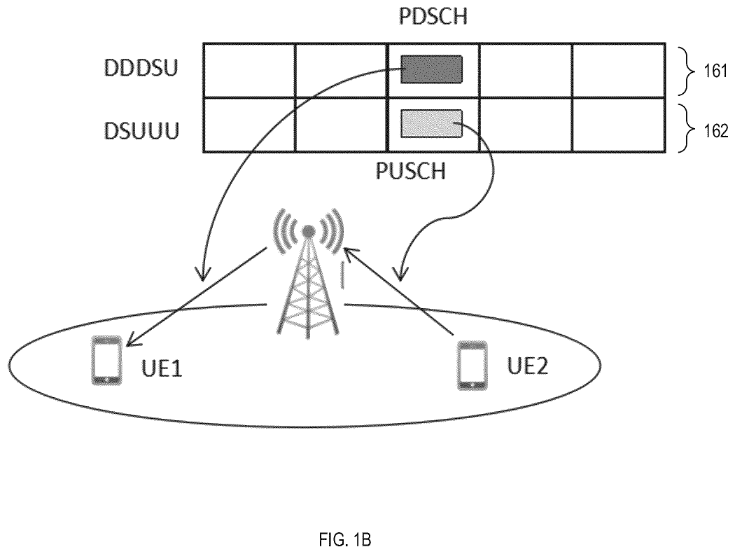

For a non-limiting example, referring to FIG. 1B, for a same cell under the base station, there are two different frequency resource with different frame structures (e.g., for slot 0, slot 1, slot 2, slot 3, and slot 4), one (161) is DDDSU, another (162) is DSUUU, wherein D represents ‘downlink’, U represents ‘uplink’, and S represents ‘flexible resource’. These frame structures may be further updated according to dynamic scheduling or dynamic frame structure indication (e.g., slot format indicator (SFI)). Then, during the middle three time intervals (e.g., slot 1, slot 2, and slot 3) may be different attributes between different frequency resources. For different UEs, the base station may transmit physical downlink shared channel (PDSCH) and receive physical uplink shared channel (PUSCH) simultaneously, for example, the base station transmits PDSCH to one UE (UE1) at slot 2, and simultaneously receives PUSCH from another UE (UE2). Under these circumstances, there may be cross-link interference for the time-frequency resources with different attributes of frame structure. Specifically, the downlink transmission of one gNB (i.e., PDSCH in FIG. 1B) may interfere with the uplink reception (i.e., PUSCH in FIG. 1B), that is, the downlink interference to the uplink. This interference may be referred as gNB self-interference under SBFD.

There may be various problems/issues associated with how to guarantee the uplink/downlink transmission performance with gNB self-interference. One of the problems/issues may include how to configure interference measurement and reporting. Upon the interference information is obtained/measured accurately and efficiently, an effective/targeted coordination between uplink/downlink transmission may be performed.

The present disclosure describes methods and devices for configuring interference measurement and reporting, addressing at least one of the issues/problems, enhancing the uplink transmission performance with gNB self-interference or inter-gNB interference.

FIG. 1A shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and an uplink communication may include a physical uplink shared channel (PUSCH) or a physical uplink control channel (PUCCH).

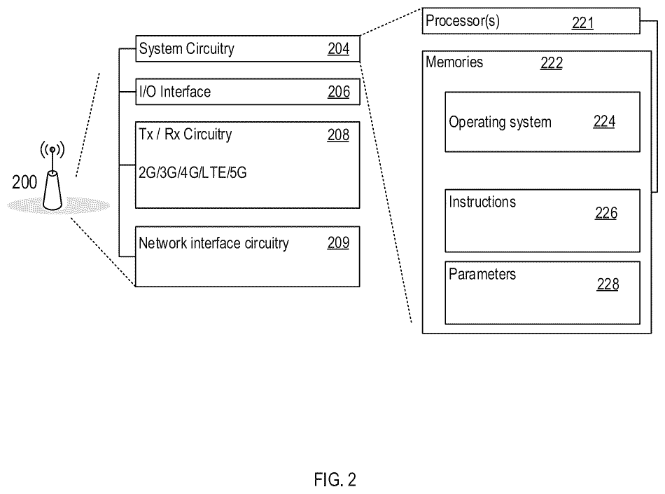

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

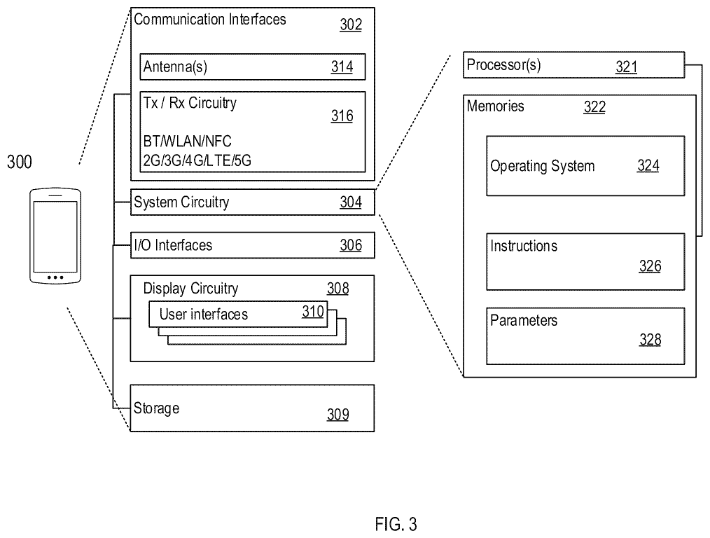

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for configuring interference measurement and reporting, which may be implemented, partly or totally, on the wireless network base station and/or the user equipment described above in FIGS. 2 and 3.

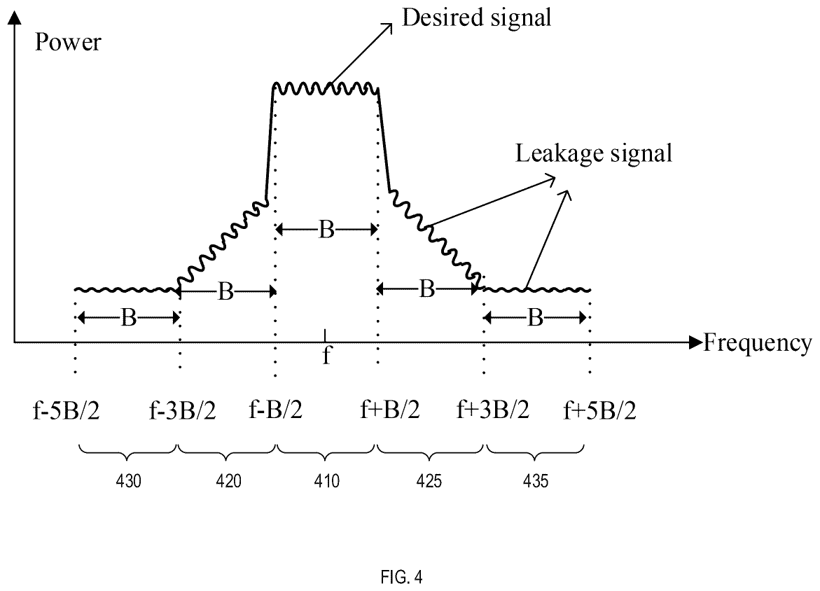

In various embodiments, referring to FIG. 4, signals need to be filtered before transmitting over the air so that signals can be restricted within the desired frequency range. The desired frequency range may be a range between f−B/2 and f+B/2 (410), wherein f is a central frequency and B is a bandwidth. Ideally, after filtering, there should be no leakage signal out of the desired frequency range. However, due to the limitation of technology and implementation complexity, there are always leakage signals out of the desired frequency range. Typically, output of signals after the filter may be shown as the example in FIG. 4. For desired signal with centre frequency at f and with bandwidth B, the leakage signal within bandwidth B that is adjacent to the desired signal (i.e., from f−3B/2 to f−B/2 (420) and from f+B/2 to f+3B/2 (425)) is stronger than the leakage signal with bandwidth B that is further away from the desired signal (e.g., from f−5B/2 to f−3B/2 (430) and from f+3B/2 to f+5B/2 (435)). Meanwhile, the leakage signal within bandwidth B that is adjacent to the desired signal is more dynamic. The leakage signal may be the interference to the desired signal within frequency resource from f−5B/2 to f−B/2 and from f+B/2 to f+5B/2. This may be referred as “roll-off filter”.

At least due to the roll-off filter effect, the uplink transmission within a UL subband, such as PUSCH, may be interfered by DL transmission within a DL subband adjacent to one side or both sides. This type of interference can be called as a gNB self-interference or an inter-subband interference.

Similarly, at least due to the roll-off filter effect, the downlink transmission within a DL subband or remaining part, such as PDSCH, may be interfered by UL transmission within a UL subband adjacent to one side or both sides. This type of interference can be called as an inter-subband UE-to-UE interference.

The present disclosure describes various embodiments of methods and devices for configuring interference measurement and reporting, addressing at least some of the issues/problems associated with the interference described above. Various embodiments may include to obtain/measure the interference levels in different frequency domains accurately and efficiently.

In some implementations, a subband level channel quality indicator (CQI) and/or precoding matrix indicator (PMI) measurement and reporting may be implemented, wherein a bandwidth part (BWP) may be divided into multiple measurement subbands in a pre-defined manner. For example, as shown in Table 1, two candidate values of measurement subband size are predefined for each range of bandwidth of the BWP, i.e., a quantity of physical resource blocks (PRBs) in the bandwidth of the BWP; and/or a radio resource control (RRC) parameter (e.g., subbandSize) may be used for configuring one of them as the final size of the measurement subband.

TABLE 1
Configurable measurement subband sizes

| Bandwidth part (PRBs) | Measurement Subband size (PRBs) |
|---|---|
| 24-72 | 4, 8 |
| 73-144 | 8, 16 |
| 145-275 | 16, 32 |

In some implementations, a size of the first measurement subband and a size of the last measurement subband are also related with the position of BWP within the carrier. More specifically, the first measurement subband size may be given by N_{PRB}^{SB}−(N_{BWP,i}^{start} mod N_{PRB}^{SB}); and the last measurement subband size may be given by (N_{BWP,i}^{start}+N_{BWP,i}^{size})mod N_{PRB}^{SB} if (N_{BWP,i}^{start}+N_{BWP,i}^{size})mod N_{PRB}^{SB}≠0 and N_{PRB}^{SB} if (N_{BWP,i}^{start}+N_{BWP,i}^{size})mod N_{PRB}^{SB}=0. N_{BWP,i}^{start} is the common resource block where BWPᵢ starts relative to common resource block 0. N_{BWP,i}^{size} is the size of the BWPᵢ. N_{PRB}^{SB} is the size of the measurement subband determined according to Table 1 and configuration by an RRC parameter (e.g., subbandSize). In the present disclosure, “mod” may refer to a modulo operation, which returns the remainder of a division, after one number is divided by another.

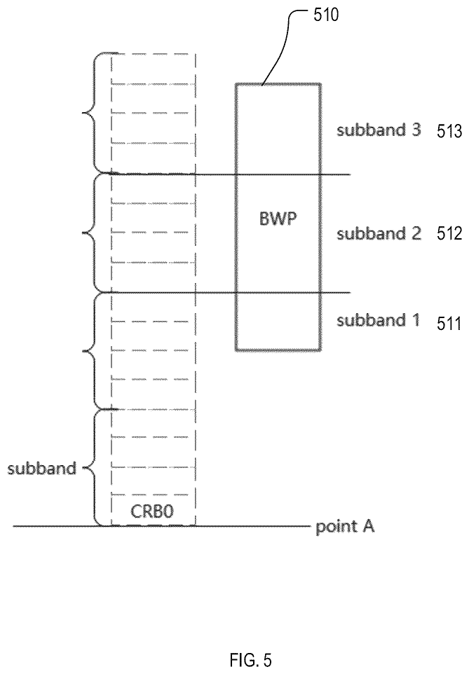

In various embodiments in the present disclosure, a “first” element may refer to a “smallest” numbered element in a group of elements; and a “last” element may refer to a “largest” numbered element in the group of elements. For an example referring to FIG. 5, a BWP (510) may include three measurement subbands (511, 512, and 513). A first measurement subband may refer to the smallest numbered measurement subband, i.e., measurement subband 1 (511); and/or a last measurement subband may refer to the largest numbered measurement subband, i.e., measurement subband 3 (513).

Referring the example shown in FIG. 5, N_{PRB}^{SB} may be 4 (i.e., 4 PRBs). A size of the first measurement subband (i.e., measurement subband 1) is 2 PRBs, a size of the last measurement subband (i.e., measurement subband 3) is 3 PRBs, and a size of other measurement subband, including measurement subband 2 (512), is 4 PRBs.

The present disclosure describes various embodiment for measurement subband level interference measurement and reporting, addressing at least one of the following problems/issues: how to configure a measurement subband in a time domain region in which an uplink (UL) subband is configured, and/or how to perform measurement subband-based measurement reporting.

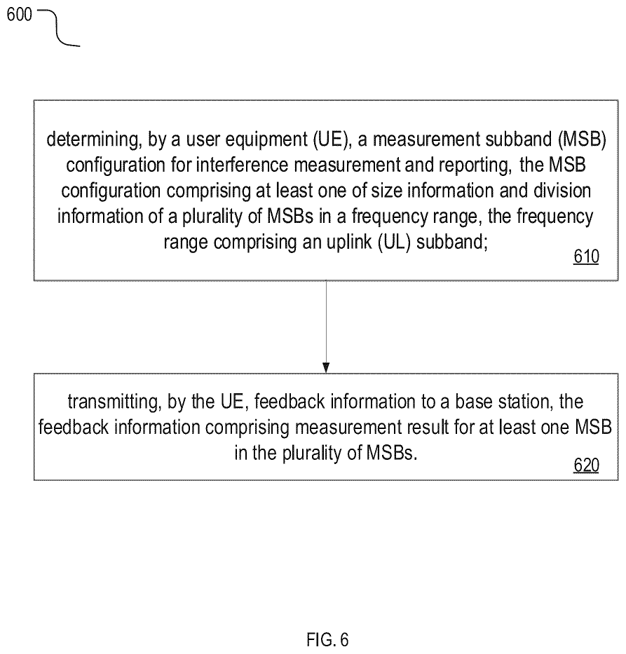

In various embodiments, FIG. 6 shows a flow diagram of a method 600 for wireless communication. The method 600 may include a portion or all of the following steps: step 610, determining, by a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and/or step 620, transmitting, by the UE, feedback information to a base station, the feedback information comprising measurement result for at least one MSB in the plurality of MSBs.

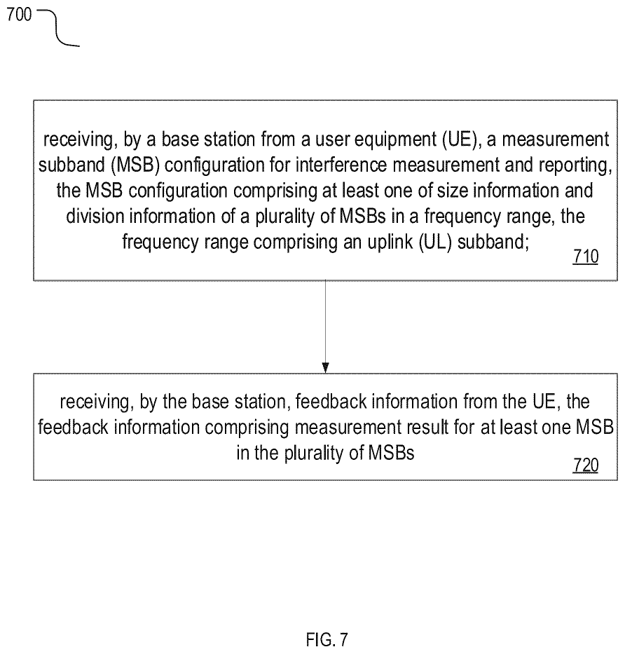

In various embodiments, FIG. 7 shows a flow diagram of a method 700 for wireless communication. The method 700 may include a portion or all of the following steps: step 710, receiving, by a base station from a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and/or step 720, receiving, by the base station, feedback information from the UE, the feedback information comprising measurement result for at least one MSB in the plurality of MSBs.

In some implementations, in additional to a portion or a combination of the described implementations/embodiments, the size information of the plurality of MSBs in the frequency range comprises an MSB size; or the MSB size is determined, according to a pre-defined table, based on one of the following: a frequency range bandwidth, a bandwidth by subtracting the UL subband from the frequency range, in response to more than one remaining parts after subtracting the UL subband from the frequency range: a bandwidth of a smallest remaining part in the more than one remaining parts, a bandwidth of a largest remaining part in the more than one remaining parts, or an averaged bandwidth of the more than one remaining parts. Each remaining part is obtained by subtracting the UL subband from the frequency range and occupies continuous spectrum resources. The frequency range can be a BWP or a group of consecutive resource blocks (RBs) within a carrier or a BWP.

In some implementations, in additional to a portion or a combination of the described implementations/embodiments, in response to the pre-defined table comprising more than one candidate MSB sizes, a radio resource control (RRC) parameter is used to indicate one of the more than one candidate MSB sizes as the MSB size.

In some implementations, in additional to a portion or a combination of the described implementations/embodiments, in response to only one remaining part after subtracting the UL subband from the frequency range, the size information of a first MSB and a last MSB in the plurality of MSBs is related with a position of the remaining part in the frequency range or in the carrier.

In some implementations, in additional to a portion or a combination of the described implementations/embodiments, in response to more than one remaining parts after subtracting the UL subband from the frequency range, the more than one remaining parts are aggregated and divided into the plurality of MSBs.

In some implementations, in additional to a portion or a combination of the described implementations/embodiments, an MSB in the plurality of MSBs crosses the UL subband; or an MSB in the plurality of MSBs contains one or more physical resource block (PRB) on both sides of the UL subband.

In some implementations, in additional to a portion or a combination of the described implementations/embodiments, the frequency range is divided into the plurality of MSBs; and/or at least one MSB in the plurality of MSBs overlaps with the UL subband.

In some implementations, in additional to a portion or a combination of the described implementations/embodiments, the in response to an MSB in the plurality of MSBs completely overlapping with the UL subband, the UE does not perform interference measurement on the MSB; and/or in response to an MSB in the plurality of MSBs partially overlapping with the UL subband, the UE performs interference measurement only a part of the MSB not overlapping with the UL subband.

In some implementations, in additional to a portion or a combination of the described implementations/embodiments, the for an MSB in the plurality of MSBs adjacent to the UL subband, the size information of the MSB is determined based on at least one of the following: a size of the frequency range; a starting physical resource block (PRB) of the frequency range; a starting PRB of the UL subband; or an ending PRB of the UL subband.

In some implementations, in additional to a portion or a combination of the described implementations/embodiments, the UE only measures the plurality of the MSBs being in a time domain resource with the UL subband.

In some implementations, in additional to a portion or a combination of the described implementations/embodiments, the UE does not measure the plurality of the MSBs being in another time domain resource without the UL subband.

In some implementations, in additional to a portion or a combination of the described implementations/embodiments, the plurality of MSBs have non-uniform sizes; and/or the size information of the plurality of MSBs is determined based on a reference MSB size.

In some implementations, in additional to a portion or a combination of the described implementations/embodiments, the size information of the plurality of MSBs is determined further based on at least one of a scaling factor and an MSB index.

In some implementations, in additional to a portion or a combination of the described implementations/embodiments, the a first MSB adjacent to the UL subband is determined as the reference MSB size, and/or a subsequent MSB relative to the first MSB is determined based on one of the following: a product of the reference MSB size and the scaling factor, or a product of the reference MSB size and the MSB index, or a product of the reference MSB size, the scaling factor, and the MSB index.

In some implementations, in additional to a portion or a combination of the described implementations/embodiments, the in response to the frequency range has two remaining parts, the two remaining parts share the reference MSB size and the scaling factor, or the two remaining parts have a different reference MSB size or a different scaling factor.

In some implementations, in additional to a portion or a combination of the described implementations/embodiments, the size of the plurality of MSBs is determined further based on a measurement result offset, wherein: a first MSB adjacent to the UL subband is determined as the reference MSB size and have an initial measurement result, and/or a subsequent MSB relative to the first MSB is determined based on the reference MSB size, the initial measurement result, and the measurement result offset.

In some implementations, in additional to a portion or a combination of the described implementations/embodiments, in response to the frequency range has two remaining parts, the two remaining parts share the reference MSB size and the measurement result offset, or the two remaining parts have a different reference MSB size or a different measurement result offset.

In some implementations, in additional to a portion or a combination of the described implementations/embodiments, the feedback information comprises a first part and a second part, wherein: the first part has a fixed size; and/or the first part indicates a size of the second part.

In some implementations, in additional to a portion or a combination of the described implementations/embodiments, the first part comprises a bitmap; each bit of the bitmap indicates whether a corresponding MSB in the plurality of the MSBs is fed back; and/or the fixed size of the first part has a same value as a number of MSBs in the plurality of the MSBs.

In some implementations, in additional to a portion or a combination of the described implementations/embodiments, the first part comprises a boundary MSB index indicating a range of MSBs in the plurality of the MSBs is fed back.

In some implementations, in additional to a portion or a combination of the described implementations/embodiments, the first part comprises a bitmap; each bit of the bitmap indicates whether a corresponding MSB shares a same measurement result as an adjacent MSB; and/or the fixed size of the first part has a same value as a number of MSBs in the plurality of the MSBs.

In some implementations, in additional to a portion or a combination of the described implementations/embodiments, a lower bit in the bitmap corresponds to a lower-frequency MSB in the plurality of the MSBs; in response to a bit being same value as a lower bit adjacent to the bit, a corresponding MSB shares a same measurement result as a lower-frequency MSB adjacent to the corresponding MSB; and/or in response to a bit being different value to a lower bit adjacent to the bit, a corresponding MSB has a different measurement result as a lower-frequency MSB adjacent to the corresponding MSB.

### Embodiment 1

The present disclosure describes non-limiting embodiments for measurement subband configuration for interference measurement and reporting. A BWP is used as a non-limiting example of frequency range in the following description for various embodiments.

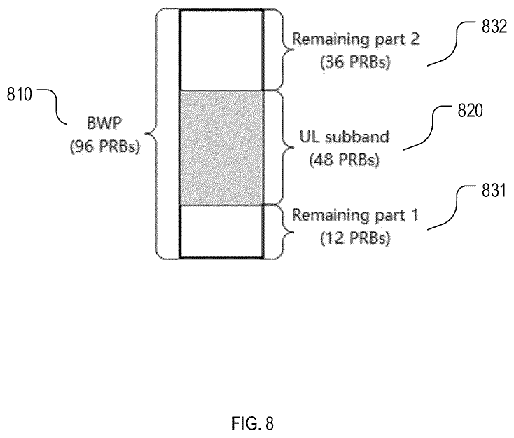

In some implementations, there are at least three different methods for determining measurement subband (MSB) size for a BWP including a UL subband. For a non-limit example in FIG. 8, a BWP (810) includes 96 PRBs: a UL subband (820) is configured within the BWP, and the UL subband includes 48 PRBs. Two remaining parts are obtained when the UL subband is subtracted from the BWP: a first remaining part (remaining part 1, 831) includes 12 PRBs, and a second remaining part (remaining part 2, 832) includes 36 PRBs.

Referring to one method for determining measurement subband (MSB) size, the bandwidth of the BWP may be used for determining the size of MSB according to a pre-defined rule. The pre-defined rule may include Table 1 or a new defined configurable MSB size table. As an example, 96 PRBs belongs to the range of {73-144}PRBs in Table 1, so the candidate sizes of MSB are 8 and 16. An RRC parameter (e.g., subbandSize) may be used for indicating one of them.

Referring to another method for determining measurement subband (MSB) size, subtracting the UL subband bandwidth from the BWP bandwidth obtains the size A (i.e., including, remaining part 1 and remaining part 2), and the candidate MSB sizes is determined in accordance with the size A according to a pre-defined rule. The pre-defined rule may include Table 1 or a new defined configurable MSB size table. More specifically, according to Table 1, the size A of 48 (i.e., 96-48) PRBs belongs to the range of {24-72} PRBs, so the candidate sizes of MSB are 4 and 8. A RRC parameter (e.g., subbandSize) may be used for indicating one of them.

Referring to another method for determining measurement subband (MSB) size, in FIG. 8, there are two remaining parts (i.e., remaining part 1 and remaining part 2) after subtracting the UL subband from the BWP. Then, the candidate sizes of MSB can be determined according to either of the size of remaining part. For example, the size of the smallest remaining part may be used for determining the candidate sizes of MSB: a size of remaining part 1 (i.e., 12 PRBs) is used for determining the candidate sizes of MSB according to a pre-defined rule. The pre-defined rule may include Table 1 by adding a new row corresponding to a size range being smaller than 24 PRBs or a new defined configurable MSB size table. Alternately, the size of largest remaining part (i.e., remaining part 2, 36 PRBs) may be used for determining the candidate sizes of MSB according to a pre-defined rule. The pre-defined rule may include Table 1 or a new defined configurable MSB size table. Alternatively, in some other implementations, an average of multiple remaining part sizes (i.e., (12+36)/2=24 PRBs) is used to determine the candidate sizes of MSB according to a pre-defined rule. The pre-defined rule may include Table 1 or a new defined configurable MSB size table.

In some implementations, a new configurable MSB size table may be defined; and the new table includes the relationship between bandwidth less than 24 PRBs and candidate MSB sizes.

This embodiment presents a method for measurement subband configuration for interference measurement and reporting. This method may effectively configuration subband based CLI measurement and reporting. Therefore, a more accurate measurement result can be obtained for subsequent interference coordination.

### Embodiment 2

The present disclosure describes non-limiting embodiments for measurement subband configuration for interference measurement and reporting.

In some implementations, an MSB division may be restricted in a remaining part (RP). In this way, the size of the first MSB and the last MSB are also related with the position of the remaining part within the carrier. More specifically, the first MSB size is given by N_{PRB}^{MSB}−(N_{RP,i}^{start} mod N_{PRB}^{MSB}) and the last MSB size given by (N_{RP,i}^{start}+N_{RP,i}^{size})mod N_{PRB}^{MSB} if (N_{RP,i}^{start}+N_{RP,i}^{size})mod N_{PRB}^{MSB}≠0 and N_{PRB}^{MSB} if (N_{RP,i}^{start}+N_{RP,i}^{size})mod N_{PRB}^{MSB}=0. N_{RP,i}^{start} is the common resource block where RPᵢ starts relative to common resource block 0. N_{RP,i}^{size} is the size of the RPᵢ. N_{PRB}^{MSB} is the size of the MSB determined according to Table 1 and configuration by an RRC parameter (e.g., subbandSize).

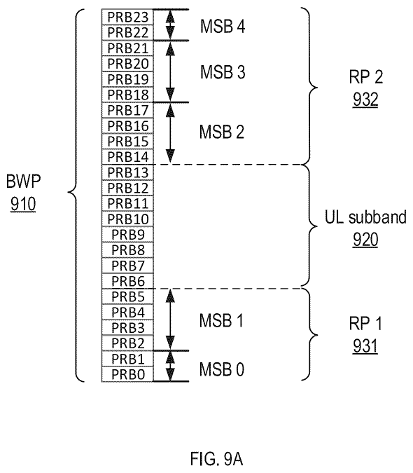

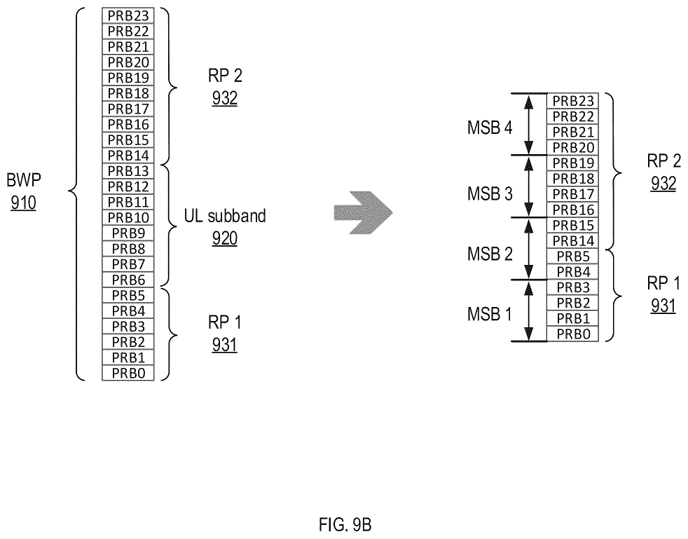

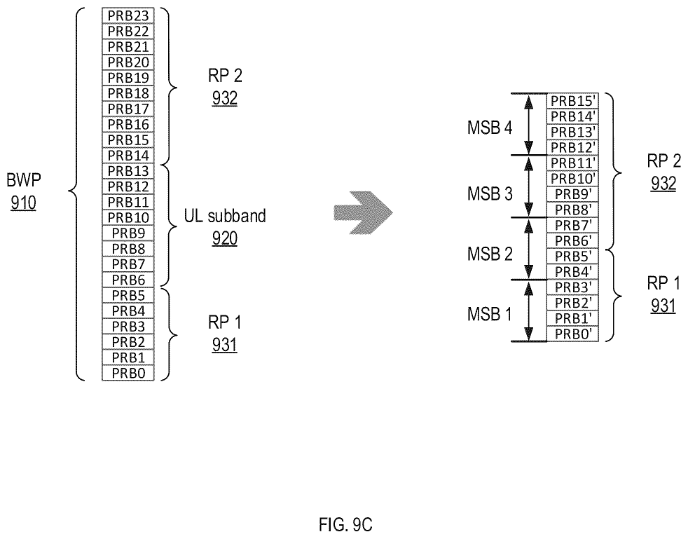

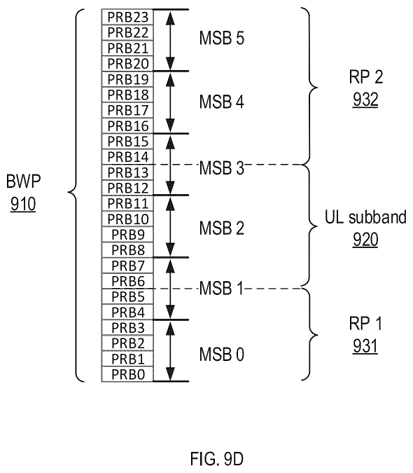

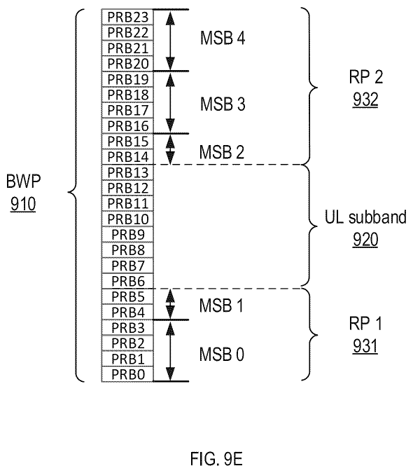

In some implementations, an MSB division may be restricted in a remaining part (RP) and taking the boundaries as reference points. For a non-limiting example as shown in FIG. 9A, for a RP lower than an UL subband (920) configured in a BWP (910) in a frequency domain, i.e., RP1 (931), the size of the first MSB (i.e., MSB 0) in the RP1 is determined as N_{RP,1}^{size} mod N_{PRB}^{MSB}; and the size of remaining MSB (e.g., MSB1) in the RP1 equals to N_{PRB}^{MSB}. For another RP higher than the UL subband in the frequency domain, i.e., RP2 (932), the size of the last MSB (i.e., MSB 4) in the RP2 is determined as N_{RP,2}^{size} mod N_{PRB}^{MSB}; and the size of remaining MSB (e.g., MSB2 and MSB3) in the RP2 equals to N_{PRB}^{MSB}.

In some implementations, the MSB division spans different remaining parts. In this case, the UL subband may affect the division of the MSB according to one of the several methods as described below.

For one method, PRBs of different remaining parts may be aggregated and divided into MSBs. Then, an MSB may cross the UL subband, that is, the MSB contains the PRBs on both sides of the UL subband. More specifically, for MSBs adjacent to or overlapping with the UL subband in the frequency domain, it includes X PRBs adjacent to the lower border of the UL subband, and Y PRBs adjacent to the upper boundary of the UL subband, wherein X=N_{PRB}^{MSB}−((N_{PRB}^{MSB}−((N_{ULSB,i}^{start}−1)mod N_{PRB}^{MSB}), and Y=(N_{ULSB,i}^{start}−1)mod N_{PRB}^{MSB} or Y=N_{PRB}^{MSB}−X. N_{ULSB,i}^{start} is the common resource block where the i-th UL subband (ULSBᵢ) starts relative to common resource block 0. N_{PRB}^{MSB} is the configured size of the MSB.

For a non-limiting example as shown in FIG. 9B, a UL subband (920) is configured in a BWP (910), resulting in two remaining parts (RPs): RP1 (931) and RP2 (932). The configured size of MSB is 4 PRBs (e.g., via a RRC parameter). An MSB (MSB 2) is overlapping with the UL subband. The size of MSB2 is 4 PRBs, including 2 PRBs adjacent to the lower border of the UL subband (i.e., PRB 4 and PRB 5) and 2 PRBs adjacent to the upper boundary of the UL subband (i.e., PRB 14 and PRB 15).

For another non-limiting example as shown in FIG. 9C, the PRBs within different remaining parts may be sequentially numbered (re-numbered). That is, for PRBs located at higher frequency comparing with UL subband, PRBₓ may be renumbered as PRB_{x-N}_{_{ULSB}}_{^{size}}, wherein N_{ULSB}^{size} is the size of the UL subband. For example, the PRB 14 within the BWP is renumbered as PRB6′, which is continuous with the PRB5′ adjacent to the low-frequency boundary of UL subband. Subsequently, in some implementations, the MSBs may be divided according an existing rule and the new PRB numbers.

For another method, the BWP may be divided into multiple MSBs according to a pre-defined rule. More specifically, the first MSB size is given by N_{PRB}^{MSB}−(N_{BWP,i}^{start} mod N_{PRB}^{MSB}) and the last subband size given by (N_{BWP,i}^{start}+N_{BWP,i}^{size})mod N_{PRB}^{MSB} if (N_{BWP,i}^{start}+N_{BWP,i}^{size})mod N_{PRB}^{MSB}≠0 and N_{PRB}^{MSB} if (N_{BWP,i}^{start}+N_{BWP,i}^{size})mod N_{PRB}^{MSB}=0. N_{BWP,i}^{start} is the common resource block and BWPᵢ starts relative to common resource block 0. N_{BWP,i}^{size} is the size of the BWPᵢ. N_{PRB}^{MSB} is the size of the subband determined according to Table 1 and configuration by a RRC parameter (e.g., subbandSize).

In some implementations, one or more MSB may overlap (completely or partially) with the UL subband. For an MSB completely overlapping with the UL subband (i.e., the MSB which is included in the UL subband), a UE may not perform interference measurement or feedback on this MSB. For an MSB partially overlapping with the UL subband, a UE may measure only the part of the MSB that do not overlap the UL subband.

For a non-limiting example as shown in FIG. 9D, the MSB 2 is completely overlapped with the UL subband, that is, MSB 2 is included in the UL subband, so that the UE may not perform interference measurement or feedback on this MSB (i.e., MSB 2). The MSB 1 partially overlaps with the UL subband, so the UE may measure only the part of MSB that do not overlap the UL subband (i.e., PRB 4 and PRB 5) and may not measure the part of MSB that overlap with the UL subband (i.e., PRB6 and PRB7). Similarly, for the MSB 3, the UE may only measure PRB 14 and PRB 15.

For another method, for an MSB adjacent to the UL subband in the frequency domain, the size of MSB is related with at least one of the following: the configured size of MSB, the index of the end PRB of the UL subband, and/or the index of start PRB of the UL subband. More specifically, the size of the first MSB at the upper side of UL subband is N_{PRB}^{MSB}−((N_{ULSB}^{end}+1)mod N_{PRB}^{MSB}), wherein N_{PRB}^{MSB} is the configured size of MSB, and N_{ULSB}^{end} is the index of the end PRB of the UL subband.

The size of the last MSB at the lower side of UL subband is (N_{ULSB}^{start}−1)mod N_{PRB}^{MSB} if (N_{ULSB}^{start}−1)mod N_{PRB}^{MSB}≠0 and N_{PRB}^{MSB} if (N_{ULSB}^{start}−1)mod N_{PRB}^{MSB}=0, wherein N_{PRB}^{MSB} is the configured size of MSB, and N_{ULSB}^{start} is the index of the start PRB of the UL subband.

For a non-limiting example as shown in FIG. 9E, only PRB 4 and PRB 5 are included in MSB 1, and only PRB 14 and PRB 15 are included in MSB 2.

### Embodiment 3

The present disclosure describes non-limiting embodiments for measurement subband configuration for interference measurement and reporting. In some implementations, when the part of measurement resource configured for interference measurement is located in the time domain resource that does not include the UL subband, a UE may not measure this resource.

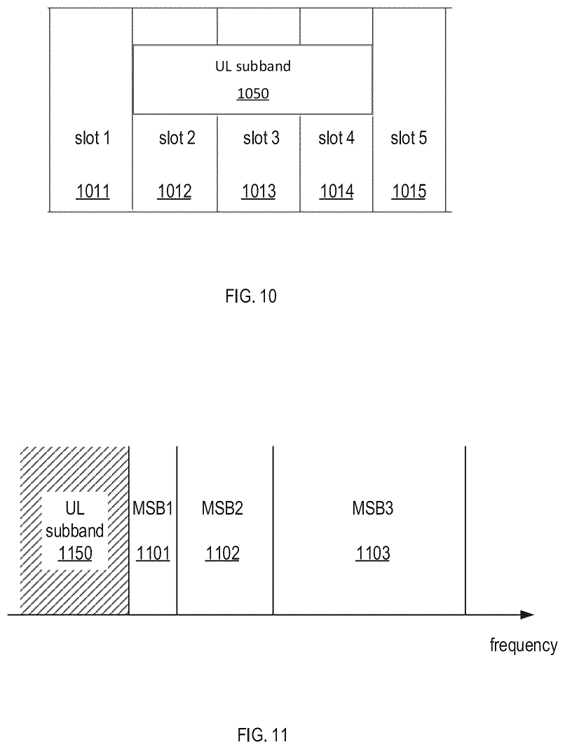

For a non-limiting example as shown in FIG. 10, a UL subband (1050) is configured within slots 2, 3, 4 (1012, 1013, and 1014). A UE may only measure the measurement resource located within slots 2, 3, and 4. The UE may not measure the measurement resource located outside of time domain resource containing the UL subband, e.g., slot 1 (1011) or slot 5 (1015).

This embodiment presents a method for measurement subband configuration for interference measurement and reporting. This method may effectively configuration subband based CLI measurement and reporting. Therefore, a more accurate measurement result can be obtained for subsequent interference coordination.

### Embodiment 4

The present disclosure describes non-limiting embodiments for measurement subband configuration for interference measurement and reporting. In some implementations, one or more MSB may be configured as non-uniform size.

For one method, a reference size of MSB N_{PRB,rf}^{MSB} may be configured, and the size of the MSBs is determined based on N_{PRB,rf}^{MSB}. For a non-limiting example, a scaling factor α is further configured, and the size of the first MSBs adjacent to the UL subband is equal to a product of the scaling factor and the reference MSB size, such as the size of the second MSBs. The size of the i-th MSB may be one of (i−1)×α×N_{PRB,rf}^{MSB} or i×α×N_{PRB,rf}^{MSB}. In the present disclosure, a “product” of A and B may refer to a result being calculated as A multiplied by B.

For another non-limiting example as shown in FIG. 11, when α=2, and the ith MSBs is: (i−1)×α×N_{PRB,rf}^{MSB}. Then, the size of first MSB (MSB1, 1101), which is adjacent to a UL subband (1150), is N_{PRB,rf}^{MSB}; the size of the second MSB (MSB2, 1102) is 2×N_{PRB,rf}^{MSB}; and the size of the third MSB (MSB3, 1103) is 4×N_{PRB,rf}^{MSB}.

For another non-limiting example, when α=1, and the ith MSBs is: i×α×N_{PRB,rf}^{MSB}. Then, the size of first MSB is N_{PRB,rf}^{MSB}; the size of the second MSB is 2×N_{PRB,rf}^{MSB}; and the size of the third MSB is 3×N_{PRB,rf}^{MSB}.

For another non-limiting example, without the scaling factor, the expression for determining the size of the ith MSB may be defined as i×N_{PRB,rf}^{MSB}, or other expressions.

In some implementations, when the UL subband is configured in the middle of the BWP, i.e., there are two remaining parts, the two remaining parts may share same configuration of N_{PRB,rf}^{MSB} and α. Alternatively, at least one of N_{PRB,rf}^{MSB} and α may be configured independently. For example, two remaining parts share a same α, but two N_{PRB,rf}^{MSB} are configured for two remaining parts respectively.

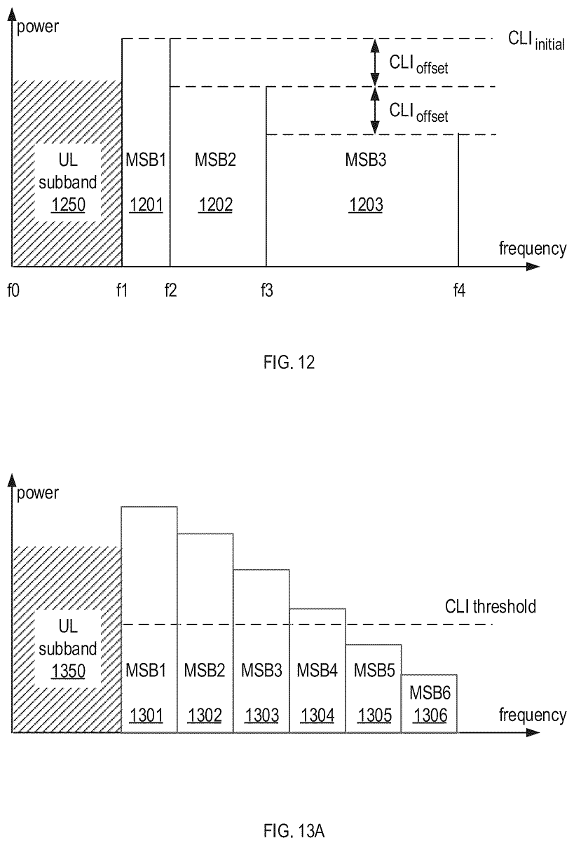

For another method as shown in FIG. 12, a reference MSB size N_{PRB,rf}^{MSB} and a measurement result offset CLI_{offset} (e.g., 3 dB) may be configured, wherein for an MSB (MSB1, 1201) adjacent to an UL subband (1250), the size of MSB1 equals to N_{PRB,rf}^{MSB}. A UE may measure MSB1 and get a measurement result CLIᵢₙᵢₜᵢₐₗ. CLI means cross link interference. More specifically, the measurement result is used to reflect interference strength, for example, a power value on a specific resource. Correspondingly, the measurement may be received signal strength indicator (RSSI) measurement on a specific measurement time-frequency resource.

The ith MSB corresponds to measurement result of CLIᵢₙᵢₜᵢₐₗ−(i−1)×CLI_{offset}. Therefore, the size of MSBs other than the first MSB (MSB1) are determined by measurement. Finally, the UE feeds back CLIᵢₙᵢₜᵢₐₗ and a plurality of frequency information (i.e., f3, f4, etc. as in FIG. 12), which is used to identify the size of other MSBs.

Optionally in some implementations, the UE may be configured with a feedback quantity or a CLI threshold. Only the MSBs whose measurement results are higher than the CLI threshold need to be fed back. Alternatively, only the MSBs whose measurement results are lower than the CLI threshold need to be fed back.

For a non-limiting example as shown in FIG. 12, assuming the size of remaining parts is 48 PRBs, and N_{PRB,rf}^{MSB} is configured as 4 PRBs, CLI_{offset} is configured as 3 dB. A method may include a portion or all of the following steps.

For step 1, a size of MSB1 (1201) is N_{PRB,rf}^{MSB}, and the frequency boundaries of MSB1 is f1 and f2. The UE measures MSB1 and get the measurement result CLIᵢₙᵢₜᵢₐₗ;

For step 2, to determine a size of MSB2 (1202), the measurement continues at a granularity of N_{PRB,rf}^{MSB} and start from frequency point f2. If the obtained measurement result is greater than CLIᵢₙᵢₜᵢₐₗ−CLI_{offset}, the measurement may be continued by expanding by another granularity of N_{PRB,rf}^{MSB}, i.e., the frequency domain range to 2×N_{PRB,rf}^{MSB}. If the measurement result is lower than CLIᵢₙᵢₜᵢₐₗ−CLI_{offset}, it is determined that the current measurement range 2×N_{PRB,rf}^{MSB} is size of MSB2. Otherwise, the measurement range will be further increased by N_{PRB,rf}^{MSB}. Until the measurement result is less than CLIᵢₙᵢₜᵢₐₗ−CLI_{offset}, and taking measurement range is size of MSB2. Then, the frequency boundaries of MSB2 being {f2, f3} may be obtained/determined.

For step 3, similar as step 2, to determine a size of MSB3 (1203), the measurement continues at a granularity of N_{PRB,rf}^{MSB} and start from frequency point f3. Finally, the frequency boundaries {f3, f4} of MSB3 may be obtained/determined. In this frequency range, the measurement result may meet the requirement of smaller than CLIᵢₙᵢₜᵢₐₗ−2×CLI_{offset}.

In some implementations, in above step 2 and/or step 3, the frequency increase may be linearly increase, for example, 1, 2, 3, 4, . . . times of N_{PRB,rf}^{MSB}; or alternatively, the frequency increase may be power increase, for example, 1, 2, 4, 8, . . . times of N_{PRB,rf}^{MSB}.

In some implementations, the measurement result in a frequency range may refer to an averaged result over the frequency range.

In some implementations, when the UE is configured with a feedback quantity of 3, the measurement results of first three MSBs (i.e., MSB1, MSB2, and MSB3) may be fed back, so that the UE may feed back CLIᵢₙᵢₜᵢₐₗ, f3, and f4.

In some implementations, the value of CLI_{offset} may be determined according to the measurement of the UE. For example, both sizes of the first MSB and the second MSB are configured, e.g., a size of MSB1 equals to N_{PRB,rf}^{MSB}, and a size of MSB2 also equals to N_{PRB,rf}^{MSB}. Then, the UE may measure MSB1 and MSB2 respectively. According to the measurement of MSB1, CLI_{MSB,1} may be obtained. According to the measurement of MSB2, CLI_{MSB,2} may be obtained. Then, CLI_{offset} may be determined/calculated by CLI_{MSB,1}−CLI_{MSB,2}. Then, similarly as described in the above step 2, the size of subsequent MSBs may be obtained/determined. The UE feeds back CLI_{MSB,1}, CLI_{MSB,2} and a plurality of frequency information (e.g., f4, etc.), which is used to identify the size of other MSBs.

In some implementations, when the remaining parts have 48 PRBs and the measurement granularity of N_{PRB,rf}^{MSB}=4, there are 48/4=12 potential frequency points. Since f3 and f4 belong to the potential frequency points, 4 bits are enough for indicating f3 or f4. More specifically as non-limiting example, f1 may be mapped with 0000, f2 may be mapped with 0001, f3 may be mapped with 0011, and/or f4 may be mapped with 0111.

In some implementations, when UL subband is configured in the middle of the BWP, i.e., there are two remaining parts, two remaining parts may share same configuration of N_{PRB,rf}^{MSB} and CLI_{offset}. Alternatively, at least one of N_{PRB,rf}^{MSB} and CLI_{offset} may be configured independently. For example, two remaining parts share a same CLI_{offset}, but two N_{PRB,rf}^{MSB} are configured for two remaining parts respectively.

This embodiment presents a method for measurement subband configuration for interference measurement and reporting. This method can effectively configuration subband based CLI measurement and reporting. Therefore, a more accurate measurement result can be obtained for subsequent interference coordination.

### Embodiment 5

The present disclosure describes non-limiting embodiments for measurement subband configuration for interference measurement and reporting. In some implementations, to save the feedback overhead, a CLI threshold may be configured, and only the MSB whose measurement result is higher or lower than the threshold is fed back.

Some implementations may have problems/issues, for example, when the quantity of MSBs for which the measurement result is greater than the threshold is uncertain, the quantity of bits fed back is also uncertain. To address this problem/issue, the feedback information may be divided into two parts, i.e., part 1 feedback information and part 2 feedback information. The part 1 feedback information has a fix size, and used for indicating the size of part 2 feedback information.

In some implementations, the part 1 feedback information and part 2 feedback information may encode independently. Specifically, the part 1 feedback information indicates which MSBs are to be fed back, and the part 2 feedback information is measurement results of each MSBs to be fed back indicated via part 1 feedback information.

The format (or content) of part 1 feedback information may be configured according to one of the following methods.

For one method, the part 1 feedback information may indicate, in a form of a bitmap, whether each of MSB should be fed back. For example, when there are 8 MSBs, 8 bits may be used for indicating which of these MSBs should be fed back. A value ‘01001000’ represents that the second MSB and the fifth MSB should be fed back. Then, the measurement results of the second MSB and the fifth MSB should be included in part 2 feedback information.

For another method, considering the measurement result of MSBs decreases with the increase of the distance between MSBs and the UL subband, a boundary MSB index may be used for indicating which MSB should be fed back.

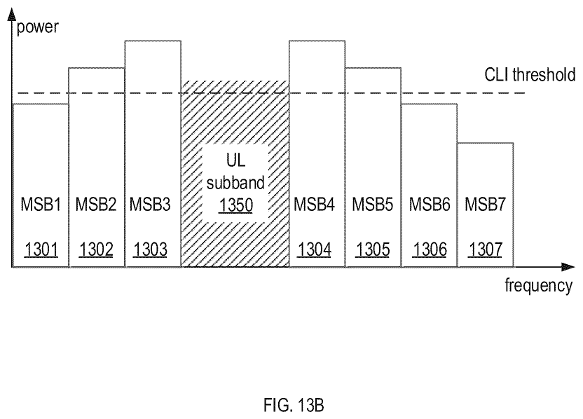

For a non-limiting example as shown in FIG. 13A, for a single-side MSB (i.e., all of MSBs are located at one side of a UL subband (1350)), and there are 6 MSBs in total, including MSB1 (1301), MSB2 (1302), MSB3 (1303), MSB4 (1304), MSB5 (1305), and MSB6 (1306). The part 1 feedback information has 3 bits for indicating a boundary MSB index (corresponding to any of the 6 MSBs). When the measurement results of the first four MSBs are higher than a CLI threshold. The boundary MSB can be a last SBB that needs to be fed back (i.e., MSB4), or a first SBB that does not need to be fed back (i.e., MSB5). Assuming the boundary MSB is defnined as the last MSB to be fed back, then, the index of the boundary MSB is 100, which corresponds to the MSB4.

For another non-limiting example as shown in FIG. 13B, when the UL subband has MSBs on both sides, including MSB1 (1301), MSB2 (1302), and MSB3 (1303) on lower frequency side of the UL subband; and MSB4 (1304), MSB5 (1305), MSB6 (1306), and MSB7 (1307) on higher frequency side of the UL subband, the boundary MSB index may be indicated for the MSBs on each side, respectively. In some implementations, the CLI threshold on different sides may be the same or different.

For the example as shown in FIG. 13B, 2 bit is required on each of the two sides to indicate a boundary MSB index, respectively. That is, for a low-frequency side of UL subband: 2 bit: 10, and for a high-frequency 2 bit: 10.

For another method, to save the feedback overhead, multiple MSBs may share a same measurement result. Channel statuses or interference statuses of these MSBs may be similar. Therefore, there are relatively similar measurement results. In this manner, the part 1 feedback information is used to indicate which MSBs share a same measurement result. Specifically, an indication field in which a bit quantity is the same as the MSB quantity is introduced, for example, in a form of bitmap.

In some implementations, each bit in the bitmap is corresponding to one MSB in a specific order. For example, a lowest bit in the bitmap is corresponding to a lowest-frequency MSB, the second lowest bit in the bitmap corresponds to the second lowest-frequency MSB, and so on. The adjacent MSBs that share a same measurement result indicate a same bit value, and when values are toggled, it indicates that subsequent MSBs are corresponding to another measurement result. For example, eight MSBs are configured, and an 8-bit bitmap indication is 10001111, indicating that the first MSB corresponds to the first measurement result, the second, third, and fourth MSBs share one measurement result (the second measurement result), and the fifth, sixth, seventh, and eighth MSBs share another measurement result (the third measurement result). Therefore, a total of only three measurement results need to be indicated in the part 2 feedback information for eight MSBs, thus lowering the amount of bits need to be transmitted and increasing the transmission efficiency.

This embodiment presents a method for subband interference measurement reporting, effectively reducing feedback overheads.

The present disclosure describes methods, apparatus, and computer-readable medium for wireless communication. The present disclosure addressed the issues with gNB self-interference. The methods, devices, and computer-readable medium described in the present disclosure may facilitate the performance of wireless communication by configuring interference measurement and reporting, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and
transmitting, by the UE, feedback information to a base station, the feedback information comprising measurement result for at least one MSB in the plurality of MSBs.

2. A method for wireless communication, comprising:
receiving, by a base station from a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and
receiving, by the base station, feedback information from the UE, the feedback information comprising measurement result for at least one MSB in the plurality of MSBs.

3. The method according to claim 1, wherein:
the size information of the plurality of MSBs in the frequency range comprises an MSB size; or
the MSB size is determined, according to a pre-defined table, based on one of the following:
a frequency range bandwidth,
a bandwidth by subtracting the UL subband from the frequency range,
in response to more than one remaining parts after subtracting the UL subband from the frequency range: a bandwidth of a smallest remaining part in the more than one remaining parts,
a bandwidth of a largest remaining part in the more than one remaining parts, or
an averaged bandwidth of the more than one remaining parts,
wherein each remaining part is obtained by subtracting the UL subband from the frequency range and occupies continuous spectrum resources.

4-7. (canceled)

8. The method according to claim 1, wherein:
the frequency range is divided into the plurality of MSBs; and
at least one MSB in the plurality of MSBs overlaps with the UL subband.

9. (canceled)

10. The method according to claim 1, wherein:
for an MSB in the plurality of MSBs adjacent to the UL subband, the size information of the MSB is determined based on at least one of the following:
a size of the frequency range;
a starting physical resource block (PRB) of the frequency range;
a starting PRB of the UL subband; or
an ending PRB of the UL subband.

11. The method according to claim 1, wherein:
the UE only measures the plurality of the MSBs being in a time domain resource with the UL subband.

12. (canceled)

13. The method according to claim 1, wherein:
the plurality of MSBs have non-uniform sizes; and
the size information of the plurality of MSBs is determined based on a reference MSB size.

14-18. (canceled)

19. The method according to claim 1, wherein:
the feedback information comprises a first part and a second part, wherein:
the first part has a fixed size; and
the first part indicates a size of the second part.

20-25. (canceled)

26. The method according to claim 2, wherein:
the size information of the plurality of MSBs in the frequency range comprises an MSB size; or
the MSB size is determined, according to a pre-defined table, based on one of the following:
a frequency range bandwidth,
a bandwidth by subtracting the UL subband from the frequency range,
in response to more than one remaining parts after subtracting the UL subband from the frequency range: a bandwidth of a smallest remaining part in the more than one remaining parts,
a bandwidth of a largest remaining part in the more than one remaining parts, or
an averaged bandwidth of the more than one remaining parts,
wherein each remaining part is obtained by subtracting the UL subband from the frequency range and occupies continuous spectrum resources.

27. The method according to claim 2, wherein:
the frequency range is divided into the plurality of MSBs; and
at least one MSB in the plurality of MSBs overlaps with the UL subband.

28. The method according to claim 2, wherein:
for an MSB in the plurality of MSBs adjacent to the UL subband, the size information of the MSB is determined based on at least one of the following:
a size of the frequency range;
a starting physical resource block (PRB) of the frequency range;
a starting PRB of the UL subband; or
an ending PRB of the UL subband.

29. The method according to claim 2, wherein:
the UE only measures the plurality of the MSBs being in a time domain resource with the UL subband.

30. The method according to claim 2, wherein:
the plurality of MSBs have non-uniform sizes; and
the size information of the plurality of MSBs is determined based on a reference MSB size.

31. The method according to claim 2, wherein:
the feedback information comprises a first part and a second part, wherein:
the first part has a fixed size; and
the first part indicates a size of the second part.

32. An apparatus comprising:
a memory storing instructions; and
at least one processor in communication with the memory, wherein, when the at least one processor executes the instructions, the at least one processor is configured to cause the apparatus to perform:
determining a measurement subband (MSB) configuration for interference measurement and reporting, the MSB configuration comprising at least one of size information and division information of a plurality of MSBs in a frequency range, the frequency range comprising an uplink (UL) subband; and
transmitting feedback information to a base station, the feedback information comprising measurement result for at least one MSB in the plurality of MSBs.

33. The apparatus according to claim 32, wherein:
the size information of the plurality of MSBs in the frequency range comprises an MSB size; or
the MSB size is determined, according to a pre-defined table, based on one of the following:
a frequency range bandwidth,
a bandwidth by subtracting the UL subband from the frequency range,
in response to more than one remaining parts after subtracting the UL subband from the frequency range: a bandwidth of a smallest remaining part in the more than one remaining parts,
a bandwidth of a largest remaining part in the more than one remaining parts, or
an averaged bandwidth of the more than one remaining parts,
wherein each remaining part is obtained by subtracting the UL subband from the frequency range and occupies continuous spectrum resources.

34. The apparatus according to claim 32, wherein:
the frequency range is divided into the plurality of MSBs; and
at least one MSB in the plurality of MSBs overlaps with the UL subband.

35. An apparatus comprising:
a memory storing instructions; and
at least one processor in communication with the memory, wherein, when the at least one processor executes the instructions, the at least one processor is configured to cause the apparatus to perform:
receiving, from a user equipment (UE), a measurement subband (MSB) configuration for interference measurement and reporting, the MSB configuration comprising at least one of size information and division information of a plurality of MSBs in a frequency range, the frequency range comprising an uplink (UL) subband; and
receiving feedback information from the UE, the feedback information comprising measurement result for at least one MSB in the plurality of MSBs.

36. The apparatus according to claim 35, wherein:
the size information of the plurality of MSBs in the frequency range comprises an MSB size; or
the MSB size is determined, according to a pre-defined table, based on one of the following:
a frequency range bandwidth,
a bandwidth by subtracting the UL subband from the frequency range,
in response to more than one remaining parts after subtracting the UL subband from the frequency range: a bandwidth of a smallest remaining part in the more than one remaining parts,
a bandwidth of a largest remaining part in the more than one remaining parts, or
an averaged bandwidth of the more than one remaining parts,
wherein each remaining part is obtained by subtracting the UL subband from the frequency range and occupies continuous spectrum resources.

37. The apparatus according to claim 35, wherein:
the frequency range is divided into the plurality of MSBs; and
at least one MSB in the plurality of MSBs overlaps with the UL subband.
